(19) United States
(12) Patent Application Publication
(10) Pub. No.: US 2013/0197685 A1
(43) Pub. Date: Aug. 1, 2013

(54) MEDIUM STORING DIAGRAM GENERATION PROGRAM, DIAGRAM GENERATION METHOD, AND DIAGRAM GENERATION APPARATUS

(71) Applicant: FUJITSU LIMITED, Kawasaki-shi (JP)

(72) Inventors: Tetsunari MATSUNAGA, Yokohama (JP); Hirotaka ITO, Kasugai (JP)

(73) Assignee: FUJITSU LIMITED, Kawasaki-shi (JP)

(21) Appl. No.: 13/735,167

(22) Filed: Jan. 7, 2013

(30) Foreign Application Priority Data
Jan. 27, 2012 (JP) 2012-015691

(51) Int. Cl. G06Q 10/06

(52) U.S. Cl. CPC G06Q 10/0631
USPC 700/100

(57) ABSTRACT

A computer-readable recording medium storing a program for causing a computer to execute a procedure for generating a diagram, the procedure includes: displaying a first selection screen for displaying at least a date that is on or after a date when a request to generate a diagram is received and that corresponds to a particular day of the week, on an apparatus of a requester; and generating the diagram on the basis of plan data concerning scheduled production volumes on a daily basis for a product, the diagram being configured in such a way that a time bucket for the scheduled production volumes to be displayed is changed from a daily basis to a weekly basis by using a first date selected via the first selection screen as a boundary.

### CROSS-REFERENCE TO RELATED APPLICATION

This application is based upon and claims the benefit of priority of the prior Japanese Patent Application No. 2012-015691, filed on Jan. 27, 2012, the entire contents of which are incorporated herein by reference.

### FIELD

The embodiments discussed herein are related to generation of diagrams.

### BACKGROUND

When products are produced, production control for producing products at sites is performed in accordance with a production plan in which scheduled production volumes are planned on a daily basis over a certain time period, such as a quarter fiscal year, a half fiscal year, or a fiscal year. In such a production plan, scheduled production volumes are planned on the basis of a sales plan, in which sales volumes are planned in accordance with product demand, in such a manner that balance of demand and supply is achieved for the products. A production plan has a characteristic of being more accurate in the nearer future with respect to the time point when the plan was devised and of being less accurate in the further future.

Thus, as a technique of visualizing a trend of scheduled production volumes, a display method has been proposed in which multiple time buckets whose units for a time period are different from each other are used to display the scheduled production volumes for each of the time buckets. This display method is disclosed in International Publication Pamphlet No. WO 2001/37157. In this display method, a production planning table is displayed which includes scheduled production volumes on a daily basis over a certain time period from the day for a starting point on the time axis representing lapse of time, and scheduled production volumes on a weekly basis after the certain time period. A production planner may grasp the correct trend in the near future, and also grasp the overall trend in the far future, enabling leveling of the allocation of product production to sites.

### SUMMARY

According to an aspect of invention, a computer-readable recording medium storing a program for causing a computer to execute a procedure for generating a diagram, the procedure includes: displaying a first selection screen for displaying at least a date that is on or after a date when a request to generate a diagram is received and that corresponds to a particular day of the week, on an apparatus of a requester; and generating the diagram on the basis of plan data concerning scheduled production volumes on a daily basis for a product, the diagram being configured in such a way that a time bucket for the scheduled production volumes to be displayed is changed from a daily basis to a weekly basis by using a first date selected via the first selection screen as a boundary.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a production control system according to a first embodiment;

FIG. 2 is a block diagram illustrating the functional configuration of a production control server according to the first embodiment;

FIG. 3 is a diagram illustrating exemplary day-of-week data;

FIG. 4 is a diagram illustrating exemplary G-PSI plan data;

FIG. 5 is a diagram illustrating an exemplary seek bar;

FIG. 6 is a diagram illustrating an exemplary seek bar;

FIG. 7 is a diagram illustrating an exemplary PSI table;

FIG. 8 is a flowchart of a procedure of a diagram generation process according to the first embodiment;

FIG. 9 is a diagram illustrating a first application example of a seek bar;

FIG. 10A is a first diagram illustrating a second application example of a seek bar;

FIG. 10B is a second diagram illustrating the second application example of a seek bar; and

FIG. 11 is a diagram for describing an exemplary computer which executes diagram generation programs according to the first and second embodiments.

### DESCRIPTION OF EMBODIMENTS

In the above-described production planning table, the day of the week when the display of scheduled production volumes on a weekly basis starts varies depending on the day of the week for a starting point on the time axis in the production planning table. Thus, in the above-described production planning table, the display of scheduled production volumes on a weekly basis occasionally does not start from the day of the week when sites in which, for example, factories are located, the headquarters which controls the sites, and the like start operating. For example, it is assumed that sites and the headquarters operate in a one-week cycle from Monday to Friday, and that Saturday and Sunday are holidays. In the case of the above-described production planning table, the display of scheduled production volumes on a weekly basis may start from a day of the week such as Friday which is the last day in the week. In this case, in the above-described production planning table, even when operation for a one-week cycle starts, a scheduled production volume before Friday is not displayed, and then the scheduled production volume for Friday is suddenly displayed. As a result, a person in charge or the like in a production department may fail to survey scheduled production volumes for one week from the above-described production planning table, resulting in inconvenience in performing production control. That is, the display method of related art fails to provide a diagram useful for production control.

Not only does the above-described problem arise when the production planning table is displayed, but also a similar problem arises when a graph representing the relationship between scheduled production volumes and time transition is generated.

The technology to be disclosed is devised in view of the above-described problem, and an object thereof is to provide a diagram useful for production control.

Embodiments for a diagram generation program, a diagram generation method, and a diagram generation apparatus which are disclosed in this application will be described in detail below on the basis of the drawings. These embodiments do not limit the technology to be disclosed. The embodiments may be combined with each other as appropriate as long as their processes do not contradict each other.

### First Embodiment

### System Configuration

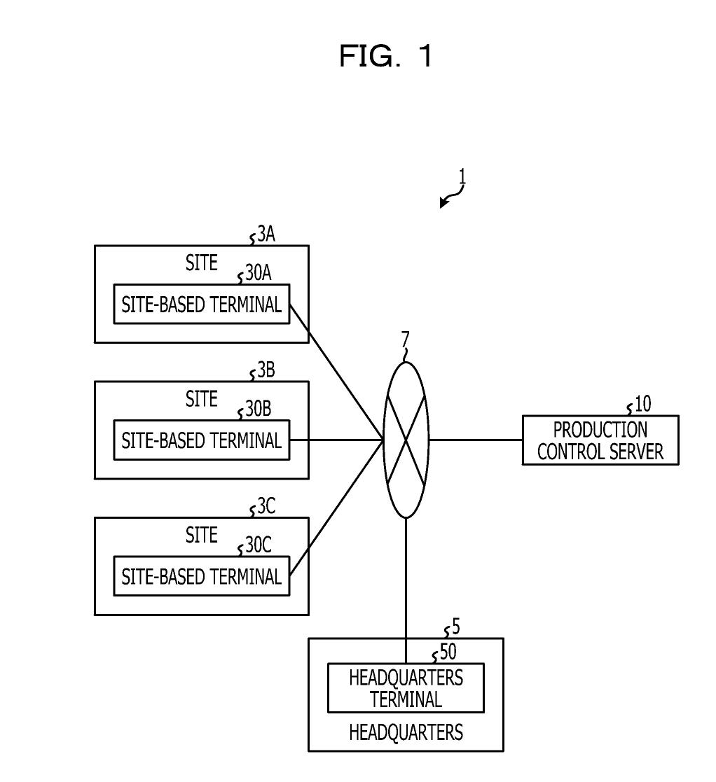

The system configuration of a production control system according to the present embodiment will be described. FIG. 1 is a diagram illustrating the configuration of a production control system according to a first embodiment. A production control system 1 illustrated in FIG. 1 controls product production at sites 3A to 3C according to a production plan in which scheduled production volumes are planned on a daily basis over a certain time period. As part of the production control, the production control system 1 provides diagram generation service for generating diagrams about sales, inventory, and production planning which include scheduled production volumes and which are provided for production planners at sites 3 or in a headquarters 5.

As illustrated in FIG. 1, the production control system 1 includes a production control server 10, site-based terminals 30A to 30C, and a headquarters terminal 50. In the example in FIG. 1, three site-based terminals and one headquarters terminal are illustrated. The disclosed system is not limited to the configuration illustrated in FIG. 1. That is, the production control system 1 may include any number of site-based terminals and headquarters terminals. Hereinafter, when each of the sites 3A to 3C is generically called without being distinguished from each other, it may be referred to as a “site 3”. In addition, when each of the site-based terminals 30A to 30C is generically called without being distinguished from each other, it may be referred to as a “site-based terminal 30”.

The production control server 10, the site-based terminals 30, and the headquarters terminal 50 are connected to each other via a network 7 so as to be capable of communicating with each other. As the network 7, any type of communications network, such as the Internet, a local area network (LAN), or a virtual private network (VPN), may be employed regardless of being wired or wireless.

A site-based terminal 30 is a terminal device which is disposed at a site 3, such as a factory where products are manufactured, or a shop where products are sold. For example, as an example of the site-based terminal 30, not only a fixed terminal such as a personal computer (PC) but also a mobile terminal, such as a portable telephone, a personal handyphone system (PHS), or a personal digital assistant (PDA), may be employed. The site-based terminal 30 is used by a member at the site 3, e.g., a person in charge in a production department or in a sales department.

The site-based terminal 30 stores and manages PSI plan data concerning sales, inventory, and production for the site 3. The term PSI represents production, sales, and inventory. Herein, a PSI plan for a site 3 may be referred to as an “L-PSI plan” because it is a local PSI plan only for each of the sites 3A to 3C. Herein, a PSI plan which is stored and managed in the production control server 10 may be referred to as a “G-PSI plan” because it is an overall PSI plan for controlling all of the sites 3.

The headquarters terminal 50 is a terminal device which is disposed in the headquarters 5 which controls the sites 3A to 3C. As an example of the headquarters terminal 50, not only a fixed terminal such as a personal computer (PC) but also a mobile terminal, such as a portable telephone, a PHS, or a PDA, may be employed. Herein, the headquarters terminal 50 is used by a member in the headquarters 5, such as a person in charge in a production department or a sales department. Here, an example is illustrated in which the headquarters terminal 50 functions as a client. However, the headquarters terminal 50 may function as the production control server 10.

The site-based terminals 30 and the headquarters terminal 50 receive and transmit various data to each other via the production control server 10 which controls master data for L-PSI plans and a G-PSI plan. In one aspect, a site-based terminal 30 uploads L-PSI plan data to the production control server 10. The L-PSI plan data includes daily production volumes, order volumes, and inventory volumes for a product. In another aspect, the headquarters terminal 50 sets scheduled production volumes for a site 3 into production planning data included in L-PSI plan data, and causes the site-based terminal 30 to download the scheduled production volumes. A scheduled production volume for the site 3 is a certain volume that is allocated from the scheduled production volume of a product planned for the entirety of the sites, by a person in charge in a production department in the headquarters 5 to the site 3 on the basis of, for example, the scheduled production volume of the product planned for the entirety of the sites, the order status and the stock status of the product, the production capacity of a factory and the loaded condition of a facility in each of the sites 3.

The production control server 10 is a server apparatus which performs production control for products. The production control server 10 may be implemented as a Web server or as a cloud. In one aspect, when the production control server 10 receives an instruction to generate a production planning table from the headquarters terminal 50, the production control server 10 uses G-PSI plan data to generate the production planning table and provides the generated table to the headquarters terminal 50. In another aspect, when the production control server 10 receives an instruction to generate a production planning table from a site-based terminal 30, the production control server 10 uses L-PSI plan data to generate the production planning table and provides the generated table to the site-based terminal 30.

The production control server 10 according to the present embodiment receives an instruction to generate a production planning table about scheduled production volumes for products. In addition, the production control server 10 according to the present embodiment causes the site-based terminals 30 and the headquarters terminal 50 to display a selection screen for providing a guide to select a date corresponding to a predetermined day of the week among dates starting from the day when the generation request is received. Further, the production control server 10 according to the present embodiment uses G-PSI plan data and L-PSI plan data including scheduled production volumes for products on a daily basis to generate a production planning table by changing the time bucket for the scheduled production volumes from a daily basis to a weekly basis by using a date which is selected via the selection screen as the boundary.

Thus, the production control server 10 according to the present embodiment accepts the selection of a date via a screen for providing a guide to select a date corresponding to a day of the week when an organization such as a company starts operating. Then, the production control server 10 generates a production planning table by changing the time bucket for the scheduled production volumes for products from a daily basis to a weekly basis by using the selected date as a boundary. Accordingly, the production control server 10 according to the present embodiment is capable of suppressing a state in which, in a diagram including scheduled production volumes, the display of scheduled production volumes on a weekly basis starts from a date other than the day of the week when, for example, the sites 3 and the headquarters 5 start operating. Therefore, using the production control server 10 according to the present embodiment, scheduled production volumes for one week may be surveyed from the production planning table. Consequently, the production control server 10 according to the present embodiment may provide a production planning table useful for production control.

Therefore, the production control server 10 according to the present embodiment may provide a production planning table useful for production control. For example, when a person in charge in a production department in the headquarters 5 views a production planning table, the person in charge may survey scheduled production volumes for the entirety of the sites 3 for one week. Accordingly, the production control server 10 may provide a production planning table which is useful for leveling of allocation of production when a person in charge in a production department in the headquarters 5 is to allocate the product production to the sites. In addition, when a person in charge in a production department in a site 3 views a production planning table, the person in charge may survey scheduled production volumes for the site 3 for one week. Accordingly, the production control server 10 may provide a production planning table which is useful to operate a factory in a site 3.

Configuration of Production Control Server 10

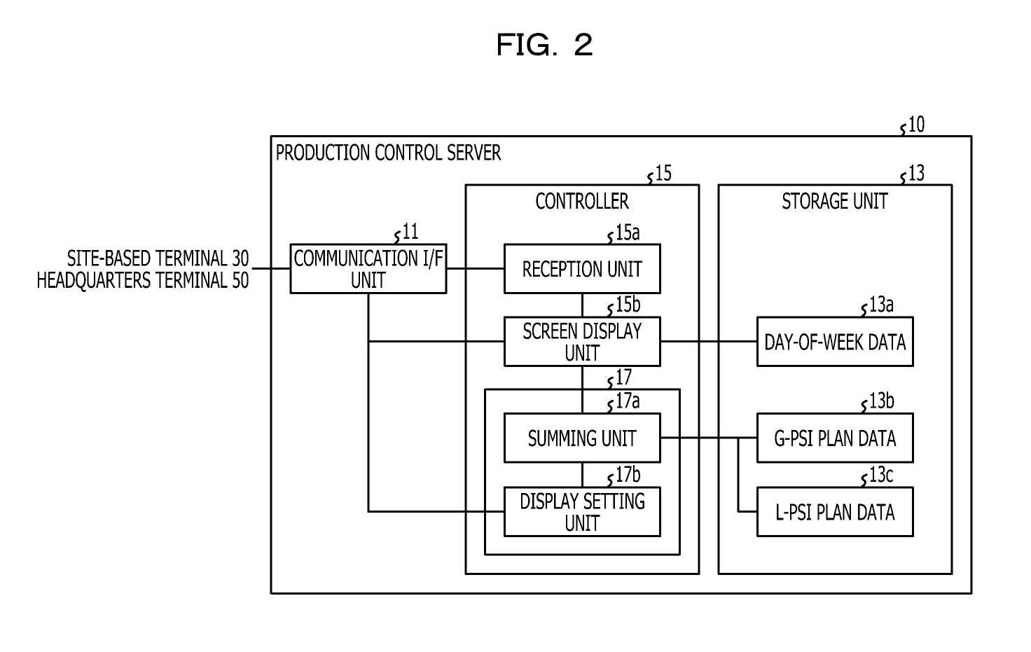

The functional configuration of the production control server 10 according to the present embodiment will be described. FIG. 2 is a block diagram illustrating the functional configuration of the production control server 10 according to the first embodiment. As illustrated in FIG. 2, the production control server 10 includes a communication interface (I/F) unit 11, a storage unit 13, and a controller 15. Other than the functional units illustrated in FIG. 2, the production control server 10 may include various functional units included in a known server apparatus, such as various input devices and audio output devices.

The communication I/F unit 11 is an interface which controls communication between the production control server 10 and other apparatuses, e.g., the site-based terminals 30A to 30C and the headquarters terminal 50. As one aspect of the communication I/F unit 11, a network interface card such as a LAN card may be employed. For example, the communication I/F unit 11 receives an instruction to generate a PSI table from the headquarters terminal 50 or a site-based terminal 30, and transmits a PSI table generated by the production control server 10 to the headquarters terminal 50 or a site-based terminal 30.

The storage unit 13 is a storage device which stores various programs, such as an operating system (OS) and graph generation programs for providing diagram generation service, which are executed by the controller 15. As one aspect of the storage unit 13, a storage device, such as a semiconductor memory element such as a flash memory, a hard disk, or an optical disk, may be employed. The storage unit 13 is not limited to the above-described types of storage devices, and may be a random access memory (RAM) or a read only memory (ROM).

The storage unit 13 stores day-of-week data 13a, G-PSI plan data 13b, and L-PSI plan data 13c as exemplary data involved in the execution of programs performed by the controller 15, as illustrated in FIG. 2.

The day-of-week data 13a is data describing various settings for the day of the week. In one example, a person in charge in a production department in a site 3 or the headquarters 5 sets the day of the week when an organization such as a company starts operating into the day-of-week data 13a. Hereinafter, a day of the week when an organization starts operating may be referred to as an “operation startup day of the week”. In another example, a person in charge in a production department in a site 3 or the headquarters 5 may set the day of the week when an organization such as a company stops operating into the day-of-week data 13a. In yet another example, a screen display unit 15b described below refers to the day-of-week data 13a in order to provide a guide to select an operation startup day of week as a first boundary date for changing the PSI time bucket for products from a daily basis to a weekly basis and provide a guide to select an operation startup day of week as a second boundary date for changing the time bucket from a weekly basis to a monthly basis.

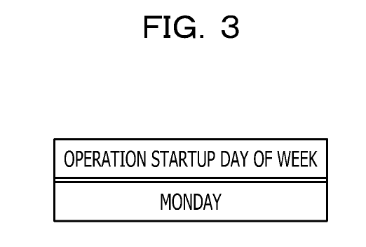

As one aspect of the day-of-week data 13a, data describing an operation startup day of the week may be employed. FIG. 3 is a diagram illustrating exemplary day-of-week data 13a. The example illustrated in FIG. 3 indicates that the sites 3 and the headquarters 5 start operating on Monday. The day of the week illustrated in FIG. 3 is merely an example, and another day of the week may be set as an operation startup day of the week.

The G-PSI plan data 13b is data describing the volumes of sales, inventory, and production for products which are scheduled for the entirety of the sites 3A to 3C. In one example, a person in charge in a production department in the headquarters 5 sets a scheduled sales volume and a scheduled inventory volume on the basis of the demand balance into the G-PSI plan data 13b, and a scheduled production volume which is set on the basis of the scheduled sales volume and the scheduled inventory volume is also registered in the G-PSI plan data 13b. Hereinafter, all of the scheduled production volume, the scheduled sales volume, and the scheduled inventory volume may be collectively referred to as “PSI data”. In another example, a generation unit 17 described below refers to the G-PSI plan data 13b when an instruction to generate a G-PSI table is received from the headquarters terminal 50.

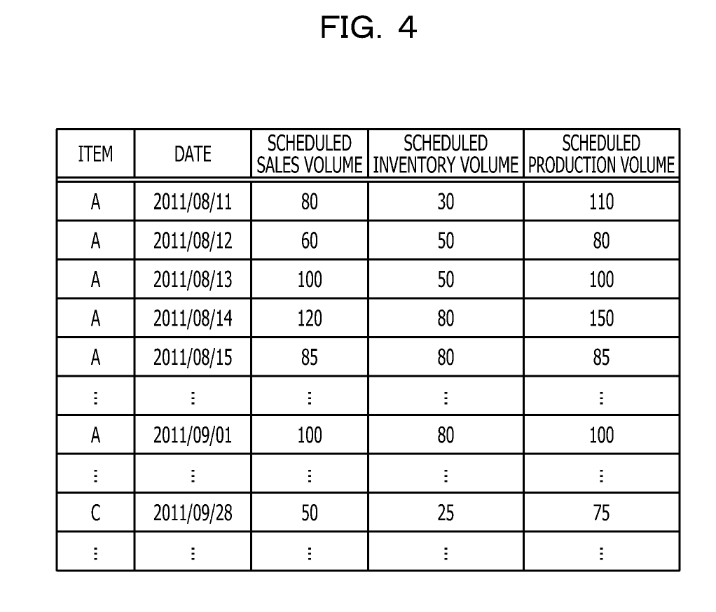

As one aspect of the G-PSI plan data 13b, data in which an “item”, a “date”, a “scheduled sales volume”, a “scheduled inventory volume”, and a “scheduled production volume” are associated with each other may be employed. FIG. 4 is a diagram illustrating exemplary G-PSI plan data 13b. As illustrated in FIG. 4, a plan for a product item “A” on Aug. 11, 2011 is described in which 80 units are to be sold and in which 30 units are to be stored as a stock. In the case where it is assumed that the initial inventory is zero, the plan is made in which the scheduled production volume is 110, which is obtained by summing the scheduled sales volume and the scheduled inventory volume, so that the inventory is to be 30 units. In addition, a plan for the product item “A” on Aug. 12, 2011 is described in which 60 units are to be sold and in which 50 units are to be stored as a stock. In this case, since the inventory on the previous date is 30 units, 80 units are to be manufactured so that the inventory is to be 50 units including the inventory on Aug. 12, 2011.

In the example in FIG. 4 as described above, exemplary production planning data is illustrated in which PSI data is associated with an item. However, the identification information of a product which is associated with PSI data does not have to be an item. For example, the disclosed apparatus may store PSI plan data in which, instead of an item, an item type which is so-called series item is associated with PSI data. The term “item type” here refers to a group of items obtained by classifying items having certain commonality as a series. For example, an item type is defined as a product unit that is managed as G-PSI plan data by the production control server 10. When the production control server 10 allocates PSI data to each of the sites 3, the production control server 10 may distribute L-PSI plan data in which an item included in an item type is used as a unit.

The L-PSI plan data 13c is data describing the volumes of sales, inventory, and production for a product which are scheduled for each of the sites 3A to 3C. In one example, a person in charge in a production department in the headquarters 5 sets a scheduled sales volume, a scheduled inventory volume, and a scheduled production volume which are allocated to a site 3 into the L-PSI plan data 13c. In another example, when an instruction to generate an L-PSI table is received from a site-based terminal 30, the generation unit 17 described below refers to the L-PSI plan data 13c. The scheme of the L-PSI plan data 13c is similar to that of the above-described G-PSI plan data 13b, and will not be described.

The controller 15 includes an internal memory for storing programs describing various procedures and control data, and executes various processes by using these programs and data. As illustrated in FIG. 2, the controller 15 includes a reception unit 15a, the screen display unit 15b, and the generation unit 17.

The reception unit 15a is a processor which receives a request to generate a PSI table including scheduled production volumes for products. In one aspect, the reception unit 15a performs login authentication on the basis of authentication information of a login which is received from a site-based terminal 30 or the headquarters terminal 50, and receives a request to generate a PSI table for product items that are specified in the request. At that time, the reception unit 15a may also perform authority authentication so as to determine whether or not a member who has succeeded in passing the login authentication has access permission to the G-PSI plan data 13b or the L-PSI plan data 13c.

The screen display unit 15b is a processor which displays a selection screen for providing a guide to select a date corresponding to the day of the week which is set in the day-of-week data 13a, among dates starting from the day when a request to generate a PSI table is received, on a site-based terminal 30 or the headquarters terminal 50.

In one aspect, the screen display unit 15b sets the date when the reception unit 15a receives a request to generate a PSI table, as a starting date on the time axis in a PSI table, and reads out the day-of-week data 13a stored in the storage unit 13. A starting date on the time axis in a PSI table does not have to be the date when a request to generate a PSI table is received, and may be before or after the date. The screen display unit 15b extracts dates that are on or after the above-described starting date and that are the day of the week which is set in the day-of-week data 13a, from calendar data in which correspondences between a date and a day of the week are defined, as selection candidates for the first boundary date. Then, the screen display unit 15b transmits a selection screen including a slider to a site-based terminal 30 or the headquarters terminal 50. A slider is displayed on a slider bar in a seek bar, and is capable of being stopped at positions corresponding to the dates extracted as selection candidates for the first boundary date.

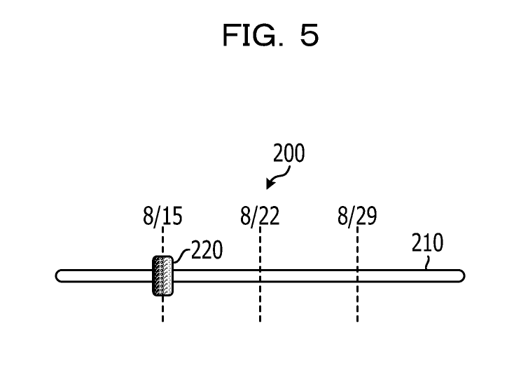

FIG. 5 is a diagram illustrating an exemplary seek bar. A reference numeral 200 illustrated in FIG. 5 denotes a seek bar included in a selection screen for selecting a first boundary date; a reference numeral 210 denotes a slider bar; and a reference numeral 220 denotes a slider. A dotted line illustrated in FIG. 5 represents the date for a selection candidate for the first boundary date. In the seek bar 200 illustrated in FIG. 5, the slider bar 210 represents the time axis. In the seek bar 200, the slider 220 may be allowed not to be stopped at any position on the slider bar 210. For example, the seek bar 200 allows the slider 220 to be stopped only at positions for the dates of August 15, August 22, and August 29 which are Mondays and which are the selection candidates for the first boundary date on the slider bar 210. Accordingly, even when the mouse pointer on the slider 220 is dragged or an arrow key is operated to a position other than the positions corresponding to August 15, August 22, and August 29 on a selection screen displayed on a site-based terminal 30 or the headquarters terminal 50, the slider 220 is not stopped at such a position on the slider bar 210. Thus, a state is suppressed in which, by selecting a date other than selection candidates for the first boundary date, the weekly-basis display of PSI data starts from a date other than the operation startup day of the week of the sites 3 and the headquarters 5. In the disclosed apparatus, an optional line (dotted line) which indicates the date of a selection candidate for the first boundary date does not have to be displayed in the seek bar 200.

After that, the screen display unit 15b receives the first boundary date selected via the selection screen in a site-based terminal 30 and the headquarters terminal 50. Then, the screen display unit 15b extracts dates that are on or after the first boundary date and that correspond to either of the day of the week that is set in the day-of-week data 13a and the first day of a month, as selection candidates for the second boundary date. After that, the screen display unit 15b transmits a selection screen including a slider which is displayed on a slider bar in a seek bar and which is capable of being stopped at positions corresponding to the dates extracted as selection candidates for the second boundary date, to a site-based terminal 30 or the headquarters terminal 50.

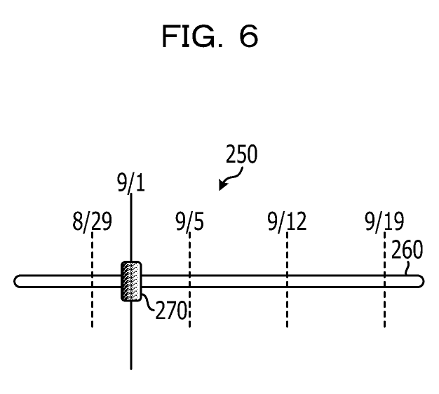

FIG. 6 is a diagram illustrating an exemplary seek bar. A reference numeral 250 illustrated in FIG. 6 denotes a seek bar included in a selection screen for selecting a second boundary date; a reference numeral 260 denotes a slider bar; and a reference numeral 270 denotes a slider. Dotted lines and a solid line illustrated in FIG. 6 each represent a date for a selection candidate for the second boundary date. A dotted line represents a date corresponding to the day of the week which is set in the day-of-week data 13a, and a solid line represents the date for the first day of a month.

In the seek bar 250 illustrated in FIG. 6, the slider bar 260 represents the time axis. In the seek bar 250, the slider 270 may be allowed not to be stopped at any position on the slider bar 260. For example, the seek bar 250 allows the slider 270 to be stopped only at positions for the dates of August 29, September 5, September 12, and September 19 which are Mondays, and September 1 which is the first day of a month, which are the selection candidates for the second boundary date on the slider bar 270. Accordingly, even when the mouse pointer on the slider 270 is dragged or an arrow key is operated to a position other than positions for the above-described selection candidates for the second boundary date on a selection screen displayed on a site-based terminal 30 or the headquarters terminal 50, the slider 270 is not stopped at such a position on the slider bar 260. Thus, a state is suppressed in which, by selecting a date other than selection candidates for the second boundary date, the monthly-basis display of PSI data starts from a date other than the operation startup day of the week of the sites 3 and the headquarters 5, or starts from a date other than the first day of a month. In the disclosed apparatus, optional lines (dotted lines and a solid line) which indicate the dates of selection candidates for the second boundary date do not have to be displayed in the seek bar 250.

Thus, the screen display unit 15b may accept selection of the first boundary date and the second boundary date from a site-based terminal 30 or the headquarters terminal 50 by displaying a selection screen including the seek bar 200 or the seek bar 250 on the site-based terminal 30 or the headquarters terminal 50. An example is illustrated in which a PSI table is generated in which the time bucket for PSI data for products is changed from a daily basis to a weekly basis on the first boundary date which is used as a boundary, and is changed from weekly basis to a monthly basis on the second boundary date which is used as a boundary. However, monthly-basis PSI data does not have to be included in a PSI table. That is, the disclosed apparatus may generate a PSI table including only daily-basis PSI data and weekly-basis PSI data.

The generation unit 17 is a processor which generates a PSI table by using the G-PSI plan data 13b and the L-PSI plan data 13c and changing the time bucket for PSI data for products from a daily basis to a weekly basis on the date that is selected via a selection screen and that is used as a boundary.

As illustrated in FIG. 2, the generation unit 17 includes a summing unit 17a which sums PSI data for products on a daily basis, a weekly basis, and a monthly basis, and a display setting unit 17b which sets the display of PSI data in a PSI table. Here, an example is assumed in which an instruction to generate a PSI table for the G-PSI plan data 13b is received from the headquarters terminal 50. A similar process is performed when an instruction to generate a PSI table for the L-PSI plan data 13c is received from a site-based terminal 30.

The description about this is that, when the first boundary date and the second boundary date are selected via the selection screens, the summing unit 17a reads out the PSI data for the time period from the starting date on the time axis in the PSI table to the previous day of the first boundary date in the G-PSI plan data 13b stored in the storage unit 13. The PSI data which is thus read out is originally on a daily basis. Accordingly, summing does not have to be performed. Therefore, the PSI data which is read out from the storage unit 13, as it is, is used as daily-basis PSI data in the following processes.

Then, the summing unit 17a sets a time period that is on or after the first boundary date and that is before the second boundary date as a weekly-basis summing period, and reads out the PSI data for the summing period from the G-PSI plan data 13b. After that, the summing unit 17a divides the summing period into time frames for the weekly-basis time bucket, and sums the PSI data for each of the time frames on a weekly basis. Then, the summing unit 17a sets a time period from a start date which is the second boundary date to an end date which is a date after a predetermined time period from the starting date on the time axis in the PSI table, for example, the last day of a month in which a date after a half fiscal year, i.e., six months, is included, as a monthly-basis summing period. The end date for the monthly-basis summing period is used under the assumption that a PSI table is displayed on a half-year basis. However, the end date is not limited to the above-described example, and any date may be used as an end date. Then, the summing unit 17a reads out the PSI data for the summing period from the G-PSI plan data 13b. After that, the summing unit 17a divides the summing period into time frames having a monthly-basis bucket size, and sums the PSI data for each of the time frames on a monthly basis.

After that, the display setting unit 17b determines whether or not a fractional time frame whose time bucket size is smaller than that for a weekly basis or a monthly basis is present. For example, the display setting unit 17b determines whether or not such a fractional time frame is present in the weekly-basis summing period, by determining whether or not each of the time frames included in the weekly-basis summing period is equal to seven days which constitute a week. In addition, the display setting unit 17b determines whether or not each of the time frames included in the monthly-basis summing period is equal to the number of days constituting a month, for example, 28 to 31 days.

The reason why the above-described determination is performed is that, when a fractional time frame is displayed in a manner equivalent to other time frames, a person in charge in a production department in a site 3 or the headquarters 5 may misunderstand the trend of the PSI data. The above-described fractional time frame is generated when the following conditions are satisfied. The first day of a month is selected as the second boundary date; and a time period from the first boundary date to the last day of the month is not a multiple of seven which is the number of days constituting a week. For example, when the first day of a month is not selected as the second boundary date, the time bucket size of the first time frame included in the monthly-basis summing period is less than one month. Even if the first day of a month is selected as the second boundary date, when a time period from the first boundary date to the last day of the month is not a multiple of seven which is the number of days constituting a week, the bucket size of the last time frame in the weekly-basis summing period is less than one week, and is one to six days. If such a fractional time frame is displayed in a PSI table in a manner equivalent to other time frames, the time bucket size of the fractional time frame is misunderstood as having a bucket size equivalent to that of other time frames although being smaller than that of other time frames. As a result, the PSI value may be underestimated.

In terms of suppressing the misconception of a trend, the display setting unit 17b changes the display setting of the fractional time frame into one different from that for other time frames. In one example, the display setting unit 17b sets the column in which a fractional time frame is displayed to a fill-pattern mode, whereas the display setting unit 17b sets the column in which a time frame which is not fractional is displayed to the plain mode. In another example, the display setting unit 17b sets the display color of the column in which a fractional time frame is displayed to a color different from that in a column in which a time frame which is not fractional is displayed.

After that, the display setting unit 17b generates a PSI table whose format is tabular, from the PSI data resulting from the summation performed by the summing unit 17a on a daily basis, a weekly basis, and a monthly basis, in accordance with the display setting which is set in advance. Then, the display setting unit 17b displays the generated PSI table for products on the headquarters terminal 50. An example is described in which the generation unit 17 generates a PSI table. However, the format of a diagram is not limited to this, and the disclosed apparatus may generate other diagrams. In one example, the disclosed apparatus may generate a graph which describes the relationship between the PSI data for products and the temporal transition on a daily basis, a weekly basis, and a monthly basis, for example, a line chart or a bar chart.

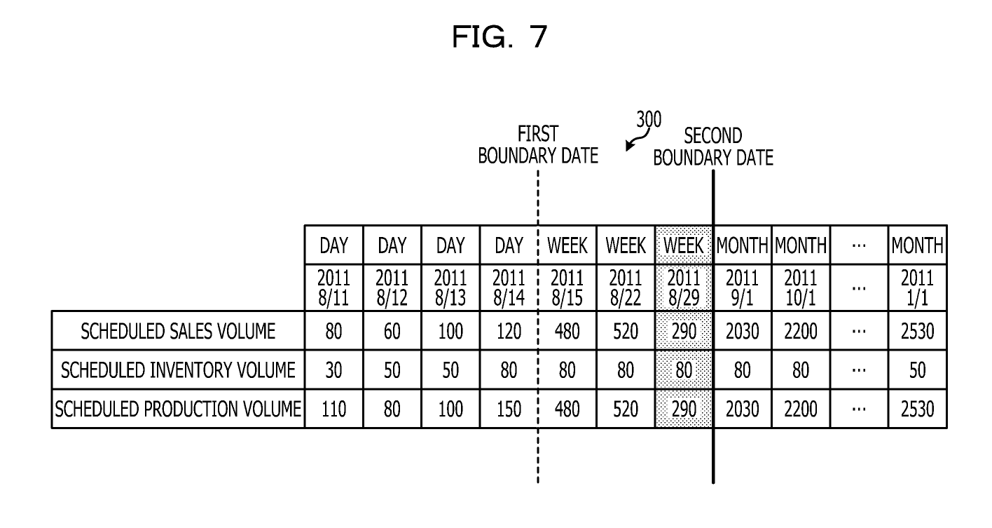

FIG. 7 is a diagram illustrating an exemplary PSI table. The example in FIG. 7 indicates that, via a selection screen, the date, August 15, is set as the first boundary date, and that the date, September 1, is set as the second boundary date. The pieces of the PSI data on a daily basis, a weekly basis, and a monthly basis illustrated in FIG. 7 are values generated by using the G-PSI plan data 13b illustrated in FIG. 4.

As illustrated in FIG. 7, in a PSI table 300, the time bucket size for the PSI data is changed from a daily basis to a weekly basis by using the date, August 15, which is a first boundary date, as a boundary. At that time, a guide has been provided by using the slider 220 included in a selection screen so that an operation startup day of the week is selected. Accordingly, the date, August 15, which is an operation startup day of the week has been selected on the headquarters terminal 50. Therefore, the display of the PSI data on a weekly basis starts from Monday, and the PSI data for one week from August 15 may be surveyed.

In the PSI table 300, the time bucket size for the PSI data is changed from a weekly basis to a monthly basis by using the date, September 1, which is a second boundary date, as a boundary. At that time, a guide has been provided by using the slider 270 included in a selection screen so that an operation startup day of the week or the first day of a month is selected. Accordingly, the date, September 1, which is the first day of a month has been selected on the headquarters terminal 50. Therefore, the display of the PSI data on a monthly basis starts from the first day of a month, and the PSI data for the month of September may be surveyed. In addition, among the time frames displayed on a weekly basis in the PSI table 300, a column for a week starting from August 29, which is a fractional time frame whose time bucket size is less than one week and which is constituted by only three days, is displayed in a fill-pattern mode. Thus, even when the scheduled production volume in the column is smaller than the PSI value in the previous week, a person in charge in a production department in the headquarters 5 may understand that one reason is that the number of days constituting the time frame is smaller than that in the previous week. Therefore, a risk of misunderstanding the PSI trend may be reduced.

By viewing the PSI table 300 as described above, a person in charge in a production department in the headquarters 5 may grasp a correct trend in the near future, and may grasp an overall trend in the distant future. Moreover, since the display of PSI data on a weekly basis starts from the operation startup day of the week and the display of PSI data on a monthly basis starts from the first day of a month in the PSI table 300, the trend of the sizes of time buckets may be correctly grasped. Therefore, a person in charge who views the PSI table 300 may achieve leveling of allocation of production when the product production is to be allocated to the sites 3.

As the controller 15, various integrated circuits and electronic circuits may be employed. In addition, some of functional units included in the controller 15 may be achieved in other integrated circuits and electronic circuits. Examples of an integrated circuit include an application specific integrated circuit (ASIC). Examples of an electronic circuit include a central processing unit (CPU) and a micro processing unit (MPU).

Process Flow

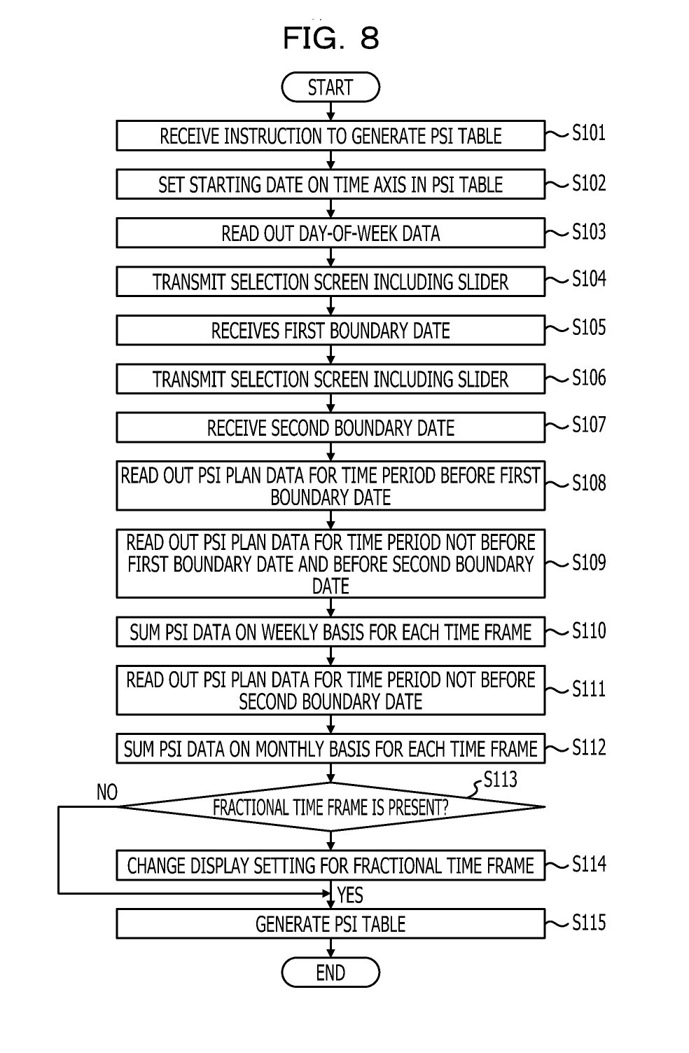

FIG. 8 is a flowchart of a procedure of a diagram generation process according to the first embodiment. The diagram generation process is invoked, for example, when an instruction to generate a PSI table is received from a site-based terminal 30 or the headquarters terminal 50.

As illustrated in FIG. 8, when the reception unit 15a receives an instruction to generate a PSI table (step S101), the screen display unit 15b sets the date when the reception unit 15a receives the instruction to generate a PSI table to a starting date on the time axis in the PSI table (step S102). Then, the screen display unit 15b reads out day-of-week data 13a stored in the storage unit 13 (step S103).

The screen display unit 15b transmits, to a site-based terminal 30 or the headquarters terminal 50, a selection screen including a slider which is capable of being stopped at positions corresponding to selection candidates for the first boundary date which are obtained by extracting dates that are on or after the above-described starting date and that correspond to the day of the week which is set in the day-of-week data 13a (step S104). After that, the screen display unit 15b receives the first boundary date selected via the selection screen on a site-based terminal 30 or the headquarters terminal 50 (step S105).

Then, the screen display unit 15b transmits, to a site-based terminal 30 or the headquarters terminal 50, a selection screen including a slider which is capable of being stopped at positions corresponding to selection candidates for the second boundary date which are obtained by extracting dates that are on or after the first boundary date and that correspond to the day of the week which is set in the day-of-week data 13a or to the first day of a month (step S106). After that, the screen display unit 15b receives the second boundary date selected via the selection screen on a site-based terminal 30 or the headquarters terminal 50 (step S107).

The summing unit 17a reads out PSI data for the time period from the starting date on the time axis in the PSI table to the previous day of the first boundary date, from the G-PSI plan data 13b stored in the storage unit 13 (step S108). The PSI data which is thus read out is originally on a daily basis, and summing does not have to be performed. Accordingly, in the processes described below, the PSI data which is read out from the storage unit 13, as it is, is used as PSI data on a daily basis.

Then, the summing unit 17a uses a time period that is on or after the first boundary date and that is before the second boundary date as a summing period on a weekly basis, and reads out the PSI data for the summing period from the G-PSI plan data 13b (step S109). Next, the summing unit 17a divides the summing period into time frames having a weekly-basis time bucket, and sums the PSI data for each of the time frames on a weekly basis (step S110).

Further, the summing unit 17a sets a time period from a start date which is the second boundary date to an end date which is a date after a predetermined time period from the starting date on the time axis in the PSI table, for example, the last day of a month in which a date after a half fiscal year, i.e., six months, is included, as a monthly-basis summing period, and reads out PSI data for the summing period (step S111). Then, the summing unit 17a divides the summing period into time frames having a monthly-basis bucket size, and sums the PSI data for each of the time frames on a monthly basis (step S112).

If a fractional time frame whose time bucket size is smaller than that for a weekly basis or a monthly basis is present (Yes in step S113), the display setting unit 17b changes the display setting for the fractional time frame into a display setting different from that for other time frames (step S114). If a fractional time frame whose time bucket size is smaller than that for a weekly basis or a monthly basis is not present (No in step S113), the process skips step S114, and proceeds to step S115.

The display setting unit 17b generates a PSI table whose format is tabular, from the PSI data resulting from the summation performed by the summing unit 17a on a daily basis, a weekly basis, and a monthly basis, in accordance with the display setting which is set in advance (step S115), and the process is ended.

As described above, the production control server 10 according to the present embodiment generates a production planning table by changing the time bucket for scheduled production volumes for products from a daily basis to a weekly basis by using, as a boundary, the date selected via a screen for providing a guide to select a date corresponding to the day of the week when the organization such as a company starts operating. That is, the production control server 10 enables a table in which a boundary between daily-basis display and a weekly-basis display varies to be automatically generated and displayed in accordance with the selected date.

Thus, the production control server 10 according to the present embodiment may suppress a state in which, in a diagram including scheduled production volumes, the display of scheduled production volumes on a weekly basis starts from a date other than the day of the week when, for example, the sites 3 and the headquarters 5 start operating. Therefore, the production control server 10 according to the present embodiment enables scheduled production volumes for one week to be surveyed from the production planning table. Consequently, the production control server 10 according to the present embodiment may provide a production planning table useful to production control.

In addition, the production control server 10 according to the present embodiment enables the display of a table to be modified by using a slider. Therefore, processes for generating and displaying multiple types of tables do not have to be repeatedly performed. As a result, the load of the production control server 10 may be reduced.

### Second Embodiment

An embodiment for the disclosed apparatus is described above. Other than the embodiment described above, various different embodiments may be implemented. Other embodiments will be described below.

First Application Example of Seek Bar

In the first embodiment described above, an example is described in which a seek bar for selecting the first boundary date and a seek bar for selecting the second boundary date are separately displayed on a site-based terminal 30 or the headquarters terminal 50. However, the disclosed apparatus may display one seek bar including these two seek bars.

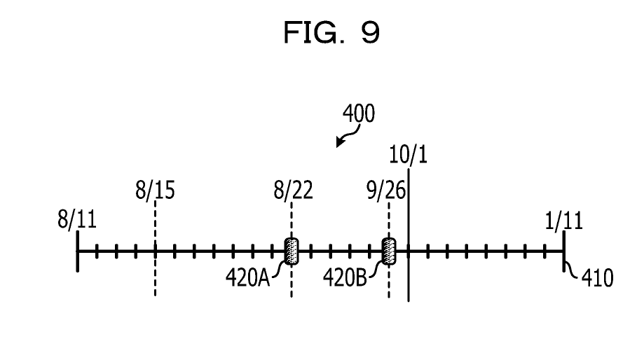

FIG. 9 is a diagram illustrating a first application example of a seek bar. In a seek bar 400 illustrated in FIG. 9, the first boundary date is selected by sliding a slider 420A along a slider bar 410, and the second boundary date is selected by sliding a slider 420B.

In the seek bar 400, the scale in the section between the starting date on the time axis in the PSI table and the slider 420A, the scale in the section between the slider 420A and the slider 420B, and the scale in the section between slider 420B and the end indicate time periods different from each other. That is, a tick mark of the scale in the section between the starting date on the time axis in the PSI table and the slider 420A indicates a “day”; a tick mark of the scale in the section between the slider 420A and the slider 420B indicates a “week”; and a tick mark of the scale in the section between slider 420B and the end indicates a “month”.

When the slider 420A is slid to the left along the slider bar 410, the section between the slider 420A and the slider 420B is widened. In this case, display is provided in such a manner that the width between tick marks of the scale in the section between the slider 420A and the slider 420B is increased in accordance with the length along which the slider 420A is slid, suppressing occurrence of a contradiction in the scale on the seek bar 400. When the slider 420A is slid to the right on the slider bar 410, the section between the slider 420A and the slider 420B is narrowed. In this case, display may be performed in such a manner that the width between tick marks of the scale in the section between the slider 420A and the slider 420B may be decreased in accordance with the length along which the slider 420A is slid. When the slider 420B is slid, the above-described adjustment control for the scale is also performed using similar logic.

Thus, the time period for the scale on the slider bar 410 is changed by using the slider 420A and the slider 420B as delimiters, enabling both of the first boundary date and the second boundary date to be accepted on a single seek bar 400.

Second Application Example of Seek Bar

In the case where the disclosed apparatus uses two seek bars which are a seek bar for selecting the first boundary date and a seek bar for selecting the second boundary date, the sliders of the seek bars may be displayed so as to be linked to each other.

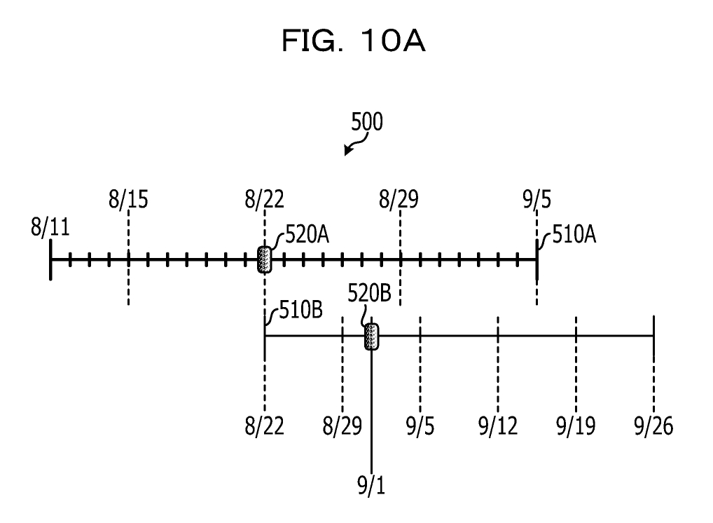

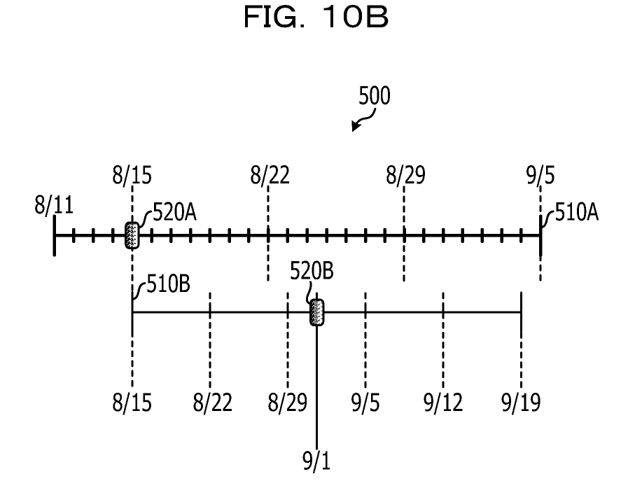

FIGS. 10A and 10B are diagrams illustrating a second application example of a seek bar. In a seek bar 500 illustrated in FIGS. 10A and 10B, the first boundary date is selected by sliding a slider 520A along a slider bar 510A, and the second boundary date is selected by sliding a slider 520B along a slider bar 510B. It is preferable to display the seek bar in such a manner that the width between tick marks of the scale of the slider bar 510B is larger than that of the slider bar 510A in the above-described seek bar 500.

In the seek bar 500 described above, the position of the slider 520A on the slider bar 510A is linked with the starting position of the slider bar 510B. That is, the starting position of the slider bar 510B is also slid so as to be aligned with the position of the slider 520A. For example, it is assumed that the slider 520A is slid from the position for the date of August 22 on the slider bar 510A as illustrated in FIG. 10A to the position for the date of August 15 on the slider bar 510A as illustrated in FIG. 10B. In this case, the starting position of the slider bar 510B is also slid to the position for the date of August 15.

Thus, the position of the slider 520A on the slider bar 510A is linked with the starting position of the slider bar 510B, enabling a person in charge in a production department to input both of the first boundary date and the second boundary date on a single selection screen.

Distribution and Integration

Components of the illustrated apparatuses do not have to be physically configured as illustrated in the figures. That is, a specific distributed or integrated configuration of the apparatuses is not limited to that in the figures. All or some of the components in any unit may be functionally or physically configured in a distributed or integrated manner in accordance with, for example, various loads or usage states. For example, the reception unit 15a, the screen display unit 15b, or the generation unit 17 may be implemented as an apparatus external to the production control server 10, and may be connected via a network. Alternatively, the reception unit 15a, the screen display unit 15b, or the generation unit 17 may be included in other respective apparatuses, and may be connected via a network so as to cooperate with each other, achieving the above-described function of the production control server 10.

Diagram Generation Program

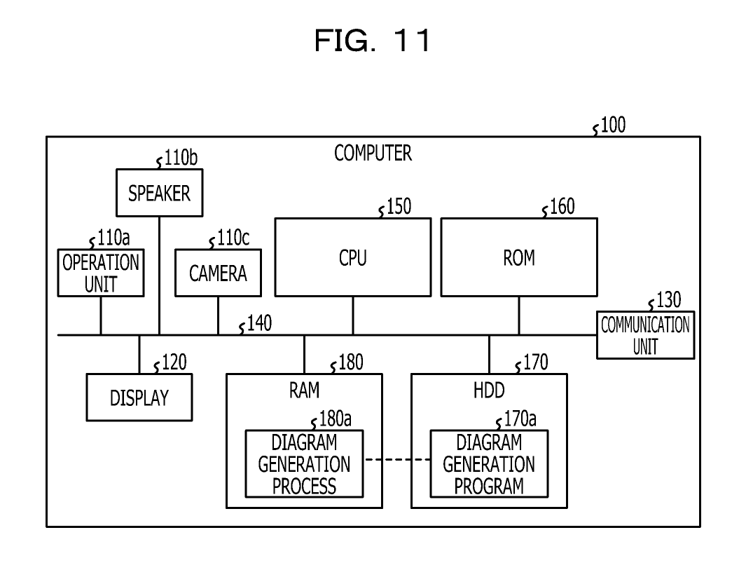

Various processes described in the above-described embodiments may be achieved with a computer, such as a personal computer or a workstation, which executes programs that are prepared in advance. Using FIG. 11, an exemplary computer which executes diagram generation programs having functions similar to the above-described embodiments will be described below.

FIG. 11 is a diagram for describing an exemplary computer which executes diagram generation programs according to the first and second embodiments. As illustrated in FIG. 11, a computer 100 includes an operation unit 110a, a speaker 110b, a camera 110c, a display 120, and a communication unit 130. In addition, the computer 100 includes a CPU 150, an ROM 160, an HDD 170, and a RAM 180. These units 110 to 180 are connected to each other via a bus 140.

As illustrated in FIG. 11, the HDD 170 stores, in advance, a diagram generation program 170a which has functions similar to those of the reception unit 15a, the screen display unit 15b, and the generation unit 17 illustrated in the first embodiment described above. The diagram generation program 170a may be implemented in a distributed or integrated manner as appropriate, like the components of each of the reception unit 15a, the screen display unit 15b, and the generation unit 17 illustrated in FIG. 2. That is, all of the pieces of data stored in the HDD 170 do not have to be stored in the HDD 170, and only data to be used for the processes may be stored in the HDD 170.

The CPU 150 reads out the diagram generation program 170a from the HDD 170 and develops it onto the RAM 180. Thus, as illustrated in FIG. 11, the diagram generation program 170a serves as a diagram generation process 180a. The diagram generation process 180a develops various data which is read out from the HDD 170 into an area allocated in the RAM 180 itself as appropriate, and executes various processes on the basis of the various data thus developed. The diagram generation process 180a includes processes executed by the reception unit 15a, the screen display unit 15b, and the generation unit 17 illustrated in FIG. 2, e.g., the processes illustrated in FIG. 8. All of the processors which are virtually implemented on the CPU 150 do not have to operate on the CPU 150 all the time, and only processors to be used for the processes may be virtually implemented.

The diagram generation program 170a described above does not have to be stored in the HDD 170 or the ROM 160 from the first stage. For example, programs are stored in a “portable physical medium”, such as a flexible disk, i.e., an FD, a CD-ROM, a DVD disk, a magneto-optical disk, or an IC card, which is inserted into the computer 100. The computer 100 may obtain programs from such a portable physical medium and execute them. Alternatively, programs may be stored in, for example, other computers or server apparatuses that are connected to the computer 100 via, for example, a public line, the Internet, a LAN, and a WAN, and the computer 100 may obtain the programs from these computers and execute them.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alterations could be made hereto without departing from the spirit and scope of the invention.

What is claimed is:

1. A computer-readable recording medium storing a program for causing a computer to execute a procedure for generating a diagram, the procedure comprising:
displaying a first selection screen for displaying at least a date that is on or after a date when a request to generate a diagram is received and that corresponds to a particular day of the week, on an apparatus of a requester; and
generating the diagram on the basis of plan data concerning scheduled production volumes on a daily basis for a product, the diagram being configured in such a way that a time bucket for the scheduled production volumes to be displayed is changed from a daily basis to a weekly basis by using a first date selected via the first selection screen as a boundary.

2. The computer-readable recording medium according to claim 1,
wherein the displaying displays the first selection screen including a slider that is displayed on a slider bar in a seek bar and that is capable of being stopped at a position for a date corresponding to the day of the week which has been set, on the apparatus of the requester.

3. The computer-readable recording medium according to claim 1, further comprising:
displaying a second selection screen on the apparatus of the requester, the second selection screen being configured in such a way that either a date that is on or after the first date which is selected via the first selection screen and that corresponds to the particular day of the week or a date that is on or after the first date which is selected via the first selection screen and that is the first day of the next month is displayed, and
wherein the generating changes the time bucket for the production volumes to be displayed from a weekly basis to a monthly basis by using a second date which is selected via the second selection screen as a boundary, and generates a diagram using the changed time bucket.

4. The computer-readable recording medium according to claim 3,
wherein the displaying of the second selection screen displays another slider that is displayed on a slider bar in a seek bar on the second selection screen and that is capable of being stopped at a position for either a date corresponding to the particular day of the week or a date of the first day of the month, on the apparatus of the requester.

5. The computer-readable recording medium according to claim 3,
wherein the generating generates, when the second date is selected, the diagram in such a manner that a production volume in a time frame whose time bucket is smaller than a time bucket on the weekly basis or the monthly basis is displayed in a manner different from a production volume in a time frame having the same time bucket as the time bucket on the weekly basis or the monthly basis.

6. A diagram generation method to be executed by a computer, the diagram generation method comprising:
receiving a request to generate a diagram;
displaying a first selection screen for displaying at least a date that is on or after a date when the request for generation is received and that corresponds to a particular day of the week, on an apparatus of a requester; and
generating the diagram on the basis of plan data concerning scheduled production volumes on a daily basis for a product, the diagram being configured in such a way that a time bucket for the scheduled production volumes to be displayed is changed from a daily basis to a weekly basis by using a first date selected via the selection screen as a boundary.

7. The diagram generation method according to claim 6,
wherein the displaying displays the first selection screen including a slider that is displayed on a slider bar in a seek bar and that is capable of being stopped at a position for a date corresponding to the day of the week which has been set, on the apparatus of the requester.

8. The diagram generation method according to claim 6, further comprising:
displaying a second selection screen on the apparatus of the requester, the second selection screen being configured in such a way that either a date that is on or after the first date which is selected via the first selection screen and that corresponds to the particular day of the week or a date that is on or after the first date which is selected via the first selection screen and that is the first day of the next month is displayed, and
wherein the generating changes the time bucket for the production volumes to be displayed from a weekly basis to a monthly basis by using a second date which is selected via the second selection screen as a boundary, and generates a diagram using the changed time bucket.

9. The diagram generation method according to claim 8,
wherein the displaying of the second selection screen displays another slider that is displayed on a slider bar in a seek bar on the second selection screen and that is capable of being stopped at a position for either a date corresponding to the particular day of the week or a date of the first day of the month, on the apparatus of the requester.

10. The diagram generation method according to claim 8,
wherein the generating generates, when the second date is selected, the diagram in such a manner that a production volume in a time frame whose time bucket is smaller than a time bucket on the weekly basis or the monthly basis is displayed in a manner different from a production volume in a time frame having the same time bucket as the time bucket on the weekly basis or the monthly basis.

11. A diagram generation apparatus comprising:
a memory configured to store a day of the week which has been set, and plan data concerning scheduled production volumes on a daily basis for a product; and
a processor configured to execute a procedure, the procedure comprising:
receiving a request to generate a diagram;
displaying a first selection screen for displaying at least a date which is on or after a date when the request for generation is received and which corresponds to the day of the week, on an apparatus of a requester; and
generating the diagram on the basis of the plan data, the diagram being configured in such a way that a time bucket for the production volumes to be displayed is changed from a daily basis to a weekly basis by using a first date selected via the selection screen as a boundary.

12. The diagram generation apparatus according to claim 11,
wherein the displaying displays the first selection screen including a slider that is displayed on a slider bar in a seek bar and that is capable of being stopped at a position for a date corresponding to the day of the week which has been set, on the apparatus of the requester.

13. The diagram generation apparatus according to claim 11, the procedure further comprising:
displaying a second selection screen on the apparatus of the requester, the second selection screen being configured in such a way that either a date that is on or after the first date which is selected via the first selection screen and that corresponds to the particular day of the week or a date that is on or after the first date which is selected via the first selection screen and that is the first day of the next month is displayed, and
wherein the generating changes the time bucket for the production volumes to be displayed from a weekly basis to a monthly basis by using a second date which is selected via the second selection screen as a boundary, and generates a diagram using the changed time bucket.

14. The diagram generation apparatus according to claim 13,
wherein the displaying of the second selection screen displays another slider that is displayed on a slider bar in a seek bar on the second selection screen and that is capable of being stopped at a position for either a date corresponding to the particular day of the week or a date of the first day of the month, on the apparatus of the requester.

15. The diagram generation apparatus according to claim 13,
wherein the generating of the diagram generates, when the second date is selected, the diagram in such a manner that a production volume in a time frame whose time bucket is smaller than a time bucket on the weekly basis or the monthly basis is displayed in a manner different from a production volume in a time frame having the same time bucket as the time bucket on the weekly basis or the monthly basis.
